(19) United States
(12) Patent Application Publication
(10) Pub. No.: US 2014/0227758 A1
(43) Pub. Date: Aug. 14, 2014

(54) INERTING METHOD IN DIGESTION

(71) Applicants: Barry Antony Tindall, High Wycombe (AU); Gareth James Buckland, Rockingham (AU)

(72) Inventors: Barry Antony Tindall, High Wycombe (AU); Gareth James Buckland, Rockingham (AU)

(73) Assignee: ANAECO LIMITED, Bentley, WA (AU)

(21) Appl. No.: 14/130,407

(22) PCT Filed: Jun. 26, 2012
(86) PCT No.: PCT/AU2012/000739

§ 371 Date: Feb. 24, 2014

(30) Foreign Application Priority Data
Jul. 1, 2011 (AU) 2011902616

(51) Int. Cl. C05F 17/00

(52) U.S. Cl. CPC C05F 17/0027
USPC 435/170

(57) ABSTRACT

A method for the inerting of vessels used in the digestion of organic waste, the method characterised by the method steps of: (i) Capturing exhaust gas (14) from a chemical conversion means (12); (ii) Directing at least a portion of the captured exhaust gas (14) from step (i) to a vessel (40) used in the digestion of organic waste; and (iii) Purging the vessel (40) using the exhaust gas (14) so as to avoid an explosive mix of gases therein, wherein the exhaust gas (14) contains sufficient oxygen to prevent substantially the production of methane by anaerobic bacteria in the vessel (40).

### FIELD OF THE INVENTION

The present invention relates to an inerting method in digestion. More particularly, the method of the present invention is intended for use in methods for the bioconversion of organic materials and the transition between aerobic and anaerobic phases, in either order.

### BACKGROUND ART

It is known that solid organic waste material may be treated under either anaerobic or aerobic conditions to produce a bioactive, stable end product that, for example, may be used as compost for gardens. This process is achieved through the action of, respectively, anaerobic or aerobic microorganisms that are able to metabolise the waste material to produce the bioactive, stable end product.

It is also known that the aerobic decomposition of solid organic waste material takes place in the presence of oxygen. The temperature of the waste material rises as some of the energy produced during aerobic decomposition is released as heat, often reaching temperatures of 75° C. under ambient conditions. The solid end product is often rich in nitrates which are a readily bio-available source of nitrogen for plants, making the end product particularly suitable as a fertiliser.

It is further known that the anaerobic digestion of solid organic waste material takes place in the absence of oxygen. Anaerobic microbial metabolism is understood to be optimised when the solid organic waste is heated to temperatures at which mesophilic or thermophilic bacteria are operative. The process of anaerobic microbial metabolism results in the production of biogas, in turn predominantly methane and carbon dioxide. The solid product of the process is often rich in ammonium salts. Such ammonium salts are not readily bio-available and are, consequently, generally treated under conditions in which aerobic decomposition will occur. In this manner the material is used to produce a product that is bio-available.

Typically, systems for the biodegradation of organic waste material are directed to either aerobic or anaerobic processes. However, there are a small number of systems that have sought to combine both anaerobic and aerobic biodegradation processes. The processes of German Patent 4440750 and International Patent Application PCT/DE1994/000440 (WO 1994/024071) each describe the combination of an anaerobic fermentation unit and an aerobic composting unit. Importantly, these systems describe discrete and separate vessels for the aerobic and anaerobic biodegradation processes.

International Patent Application PCT/AU00/00865 (WO 01/05729) describes an improved process and apparatus in which many of the inefficiencies of the previous processes and apparatus are overcome. The improved process and apparatus are characterised at a fundamental level by the sequential treatment of organic waste material in a single vessel, through an initial aerobic step to raise the temperature of the organic waste material, an anaerobic digestion step and a subsequent aerobic treatment step. During the anaerobic digestion step a process water or inoculum containing micro organisms is introduced to the vessel to create conditions suitable for efficient anaerobic digestion of the contents and the production of biogas. The introduced inoculum also aids in heat and mass transfer as well as providing buffer capacity to protect against acidification. Subsequently, air is introduced to the residues in the vessel to create conditions for aerobic degradation. It is further described that the water introduced during anaerobic digestion may be sourced from an interconnected vessel that has undergone anaerobic digestion.

The stages of aerobic loading, anaerobic digestion and aerobic composting in the process of International Patent Application PCT/AU00/00865 (WO 01/05729) occur in a single digester vessel over a 21 day period. However, multiple vessels may be utilised in an off-set manner such that each vessel is operating at a different stage of the process at any one time. At some points in the process the oxygen or methane (biogas) content of the vessel must be lowered in such a way as to avoid the generation of a flammable mix of methane in air. To date, nitrogen has been used as an inerting gas. This process uses large quantities of expensive, site stored, liquid nitrogen that has to be vapourised and purged through the reactor to an effective odour mitigation device.

U.S. patent application Ser. No. 12/493,157 (Publication US 2010/0035319) describes a method for the production of synfuel from biodegradable carbonaceous material that utilises aerobic and anaerobic stages and a stacked particle bioreactor or heap. In the transition from aerobic to anaerobic conditions it is described that the anaerobic conditions may be established either microbially or by flushing with a non-oxygenated gas. Such an inert gas is disclosed as, for example N₂ or a low oxygen (<1% O₂) content gas such as N₂/CO₂. It is further disclosed that, during digestion, CO₂ separated from the biogas is returned to the reactor to provide a positive pressure to minimise the ingress of O₂. A further benefit of the presence of this CO₂ is identified as being enhanced production of CH₄. As such, this process again requires the use of an external inerting gas to create the required anaerobic conditions.

The method of the present invention has as one object thereof to overcome substantially the abovementioned problems of the prior art, or to at least provide a useful alternative thereto.

The preceding discussion of the background art is intended to facilitate an understanding of the present invention only. The discussion is not an acknowledgement or admission that any of the material referred to is or was part of the common general knowledge as at the priority date of the application.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

### DISCLOSURE OF THE INVENTION

In accordance with the present invention there is provided a method for the inerting of vessels used in the digestion of organic waste, the method comprising the method steps of:
(i) Capturing exhaust gas from a chemical conversion means;
(ii) Directing at least a portion of the captured exhaust gas from step (i) to a vessel used in the digestion of organic waste; and
(iii) Purging the vessel using the exhaust gas so as to avoid an explosive mix of gases therein,
   wherein the captured exhaust gas contains sufficient oxygen to prevent substantially the production of methane by anaerobic bacteria.

Preferably, the oxygen content of the captured exhaust gas is sufficiently low such that the gas upon introduction to the vessel is not explosive.

The captured exhaust gas preferably contains up to 12% oxygen.

Yet still preferably, the captured exhaust gas contains about 2 to 5% oxygen.

The captured exhaust gas still preferably contains between about 10 to 21% carbon dioxide.

Preferably, the captured exhaust gas contains sufficient oxygen to inhibit by about 95% the production of methane by anaerobic bacteria.

Still preferably, the level of methane in a head space of the vessel when purged is less than about 3%.

The chemical conversion means is preferably a power generation means. Preferably, the power generation means may be provided in the form of one or more internal combustion engines, boilers, or gas turbines.

Still preferably, the power generation means runs at least in part on biogas produced during the digestion of organic waste in the vessel of step (ii).

The method of the present invention may comprise the additional method step of cooling the exhaust gas prior to step (ii).

Preferably, the exhaust gas is cooled to below about 60° C.

Still preferably, the exhaust gas is cooled to between about 50° C. to 60° C.

In one form of the present invention the method comprises the additional method step of operating the chemical conversion means in a manner such that the level of oxygen in the exhaust gas produced thereby is modified from what it might normally be when operated in accordance with routine operational requirements.

Preferably, the modification of the oxygen level is conducted in accordance with the needs of the digestion process taking place in the vessel of step (ii).

The method of the present invention may contain the additional method step of removing one or more of water, sulphur and nitrogenous gases from the exhaust gas prior to step (ii).

In one form of the present invention the exhaust gas pressure for purging in step (iii) is between about 10 to 30 kPag.

The method of the present invention may further comprise the additional method step of boosting the exhaust gas pressure between, steps (i) and (ii).

### BRIEF DESCRIPTION OF THE DRAWINGS

The present invention will now be described, by way of example only, with reference to one embodiment thereof and the accompanying drawings, in which:—

FIG. 1 is schematic representation of an inerting method for use in the inerting of vessels used in the digestion of organic waste in accordance with the present invention; and

FIG. 2 is a schematic representation of a reactor vessel used in the digestion of organic waste such as may be inerted using the method of present, invention.

### BEST MODE(S) FOR CARRYING OUT THE INVENTION

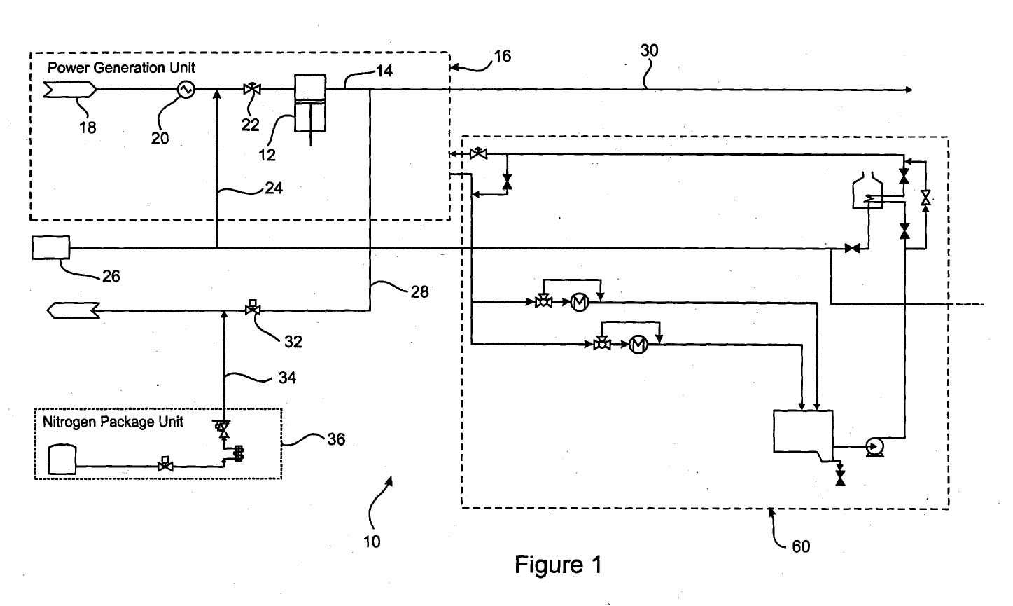

In FIG. 1 there is shown an inerting method 10 for use in the inerting of vessels used in the digestion of organic waste in accordance with the present invention. The method 10 comprises in part the operation of a chemical conversion means, for example a power generation means, which in turn may be provided in the form of a gas engine 12, to produce an exhaust gas 14.

The gas engine 12 is provided as a part of a power generation unit 16 further comprising a supply input of cleaned biogas 18, a pre-heater 20 to preheat the biogas 18, and a valve 22 that may be actuated to prevent gas flow to the gas engine 12. A natural gas input 24 is also provided at a point upstream of the valve 22. The natural gas input 24 is fed by a source of natural gas 26.

The exhaust gas 14 may either be fed by way of exhaust gas feed line 28 to the remainder of the process or it may be exhausted through exhaust line 30 to atmosphere if surplus to the requirements of the method 10 at that time.

The exhaust gas feed line 28 has a valve 32 provided therein. Additionally, the exhaust gas feed line 28 accepts a nitrogen gas feed line 34 at a point downstream of the valve 32. The nitrogen gas feed line 34 can feed nitrogen gas from a nitrogen production plant 36 provided for use in times when the power generation unit 16 is not operating, such as during scheduled maintenance. Further, nitrogen gas may be added by the nitrogen gas feed line 34 should the oxygen content of the exhaust gas be considered too high.

It is envisaged that the pre-heater 20 may be replaced with a biogas chiller (not shown) by which moisture is removed from the biogas, and a compressor (not shown) to provide an appropriate pressure for operation of the power generation unit 16.

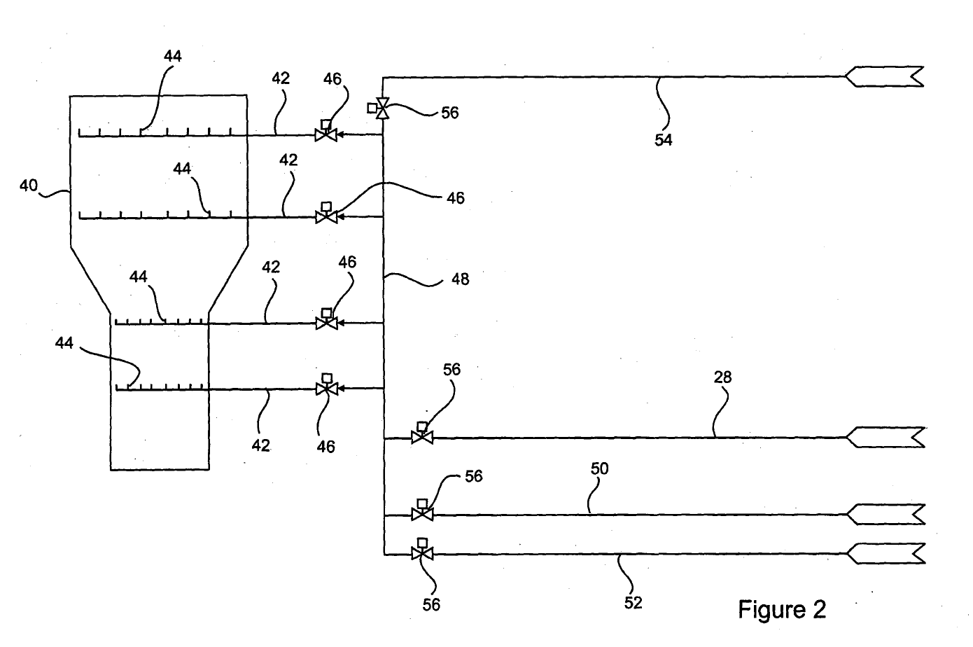

In FIG. 2 there is shown a digester vessel 40, leading into which are provided a series of fluid inlet lines 42, each with a plurality of fluid injection points 44 provided thereon that project into the digester vessel 40, by way of which fluids may be injected into the digester vessel 40 and into the organic material (not shown) housed therein. Each fluid inlet line 42 has provided therein a valve 46.

A common feed line 48 is provided in communication with each of the fluid inlet lines 42. The common feed line 48 is fed by the exhaust gas feed line 28, a first water feed line 50 and a second water feed line 52, and an air feed line 54. Each of the feed lines 28, 50, 52 and 54 have a terminal valve 56 provided therein adjacent their join with the common feed line 48.

This arrangement of feed lines allows the necessary fluids to be directed to the digester vessel 40 for different phases of the bioconversion process, for example anaerobic digestion or aerobic composting.

A heat recovery circuit 60 is provided in association with the power generation unit 16, as is seen in FIG. 1. The heat produced from the engine cooling system and/or exhaust gas cooling is recovered in the heat recovery circuit 60 and fed back to heat process liquor to maintain temperature in the system. The heat can also be used for other functions where hot water may be required.

In use, the engine exhaust 14 leaves the gas engine 12 at between 150 to 600° C. (depending on the heat recovery methods used), at a low pressure and contains up to 12% oxygen, but most suitably about 2 to 6% oxygen, for example about 2 to 5% oxygen. The captured exhaust gas contains sufficient oxygen to inhibit by about 95% the production of methane by anaerobic bacteria. The exhaust gas 14 is cooled to between 50° C. and 60° C., for example 60° C., and the gas sucked or drawn from an exhaust stack (not shown), boosting pressure to a level that can be used for purging of the digestion vessel 40. The boosted pressure of the exhaust gas 14 is about 10 to 30 kPag.

The low oxygen content of the exhaust gas 14 allows the user to add the exhaust directly to the digester vessel 40 to start purging for the transition from anaerobic to aerobic phases, for example. However, the fact that the oxygen content is up to 12% is important in terms of the inhibition of methanogens and the avoidance of an explosive atmosphere within the vessel 40. The level of methane in a head space of the vessel when purged is less than about 3%.

The lower explosive limit (LEL) of methane is reached at 12% oxygen in nitrogen and may increase in the presence of reasonable quantities of CO₂. The exhaust gas 14 is understood to contain significant quantities of CO₂ and the reasonable quantities envisaged herein are at least 10 to 21%. The further reduction proposed, in terms of the preferred about 2 to 5% oxygen, provides what is envisaged by the Applicants as a reasonable safety margin. It is envisaged that gas from an engine exhaust will have large quantities of CO₂ present so a figure of 14% is understood to be more likely in operation.

It is further envisaged that the power generation means may be operated in a manner such that the level of oxygen in the exhaust gas produced thereby is modified from what it might normally be when operated in accordance with routine operational requirements. Whether this modification of oxygen content is upward or downward will depend upon the operational requirements of the digestion process occurring in the digester vessel. That is, the particular stage of the digestion process occurring in the digester vessel.

It is envisaged that the exhaust gas may be further treated prior to passing to the digester vessel. Such further treatment may be by way of passing the exhaust gas through one or more catalytic converters, filters or scrubbers, or other such mechanical and/or chemical treatments. In this manner one or more of water, sulphur and nitrogenous gases may be removed from the exhaust gas prior to step (ii). Such nitrogenous gases may include oxides of nitrogen and unburnt flammable gases.

Anaerobic digestion of the organic fraction of municipal solid waste (OFMSW) produces biogas in quantities that make it ideal for generating power and/or heat. The biogas is harnessed in the method 10 of the present invention in this manner. The power, whether direct mechanical drive or electricity generation, can be used to make a facility that processes OFMSW self sufficient and may allow export of the generated power to external parties.

As may be noted with reference to the above description, the exhaust gas, after it has been cooled and heat recovered therefrom, is ideal as an inerting medium due to its relatively low oxygen content and can be used to purge vessels when alternating between aerobic and anaerobic phases or vice versa.

If the oxygen content of the exhaust gas 14 is too low, such as below about 2 to 5%, then inhibition of methanogens will be incomplete and inerting in the transition between aerobic and anaerobic phases will be compromised.

It is envisaged that the chemical conversion means may comprise any mechanism or apparatus that produces a suitable exhaust gas 14, with the requisite oxygen content. Such mechanisms and apparatus may include internal combustion engines, boilers, or gas turbines, flares and/or fuel cells.

The method of the present invention allows safe, rapid transitions between phases without using expensive site-stored liquid nitrogen or other inert gases. Further, the method of the present invention uses resources available on site that would otherwise be wasted.

Modifications and variations such as would be apparent to the skilled addressee are considered to fall within the scope of the present invention.

1. A method for the inerting of vessels used in the digestion of organic waste, the method characterised by the method steps of:
(i) Capturing exhaust gas from a chemical conversion means;
(ii) Directing at least a portion of the captured exhaust gas from step (i) to a vessel used in the digestion of organic waste; and
(iii) Purging the vessel using the exhaust gas so as to avoid an explosive mix of gases therein,
wherein the captured exhaust gas contains sufficient oxygen to prevent substantially the production of methane by anaerobic bacteria.

2. A method according to claim 1, wherein the oxygen content of the captured exhaust gas is sufficiently low such that the gas upon introduction to the vessel is not explosive.

3. A method according to claim 1, wherein the captured exhaust gas contains up to 12% oxygen.

4. A method according to claim 1, wherein the captured exhaust gas contains between 2 to 5% oxygen.

5. A method according to claim 1, wherein the captured exhaust gas contains between about 10 to 21% carbon dioxide.

6. A method according to claim 1, wherein the captured exhaust gas contains sufficient oxygen to inhibit by about 95% the production of methane by anaerobic bacteria.

7. A method according to claim 1, wherein the level of methane in a head space of the vessel when purged is less than about 3%.

8. A method according to claim 1, wherein the chemical conversion means is a power generation means.

9. A method according to claim 8, wherein the power generation means is provided in the form of one or more internal combustion engines, boilers, or gas turbines.

10. A method according to claim 8, wherein the power generation means runs at least in part on biogas produced during the digestion of organic waste in the vessel of step (ii).

11. A method according to claim 1, wherein the method comprises the additional method step of cooling the exhaust gas prior to step (ii).

12. A method according to claim 11, wherein the exhaust gas is cooled to below about 60° C.

13. A method according to claim 11, wherein the exhaust gas is cooled to between about 50° C. to 60° C.

14. A method according to claim 1, wherein the method comprises the additional method step of operating the chemical conversion means in a manner such that the level of oxygen in the exhaust gas produced thereby is modified from what it might normally be when operated in accordance with routine operational requirements.

15. A method according to claim 14, wherein the modification of the oxygen level is conducted in accordance with the needs of the digestion process taking place in the vessel of step (ii).

16. A method according to claim 1, wherein the method comprises the additional step of removing one or more of water, sulphur and nitrogenous gases from the exhaust gas prior to step (ii).

17. A method according to claim 1, wherein the exhaust gas pressure for purging in step (iii) is between about 10 to 30 kPag.

18. A method according to claim 1, wherein the method further comprises the additional method step of boosting the exhaust gas pressure between steps (i) and (ii).

19. A method for the inerting of vessels used in the digestion of organic waste, the method being substantially as hereinbefore described with reference to FIGS. 1 and 2.
